(19) United States
(12) Patent Application Publication
(10) Pub. No.: US 2006/0060262 A1
(43) Pub. Date: Mar. 23, 2006

(54) Cycle shortener for log splitters

(76) Inventor: Norman A. Hicks, Coudersport, PA (US)

Correspondence Address: Donald W. Meeker;Patent Agent, 924 East Ocean Front #E, Newport Beach, CA, 92661, US

(21) Appl. No.: 11/233,982

(22) Filed: Sep. 23, 2005

Related U.S. Application Data
(60) Provisional application No. 60/612,336, filed on Sep. 23, 2004.

(51) Int. Cl. B27L 7/00

(52) U.S. Cl. 144/193.2

(57) ABSTRACT

A length limiter rod is attached to an extended inward end of a control valve lever of a log splitter to allow it to stop at any point desired on a return cycle. A hitch pin on the rod contacting a shutoff guide attached to a slide wedge forces the rod rearward pulling the control valve lever to a neutral position stopping the return of the slide wedge to shorten the return length and thereby shorten the cycle time in splitting logs.

### CLAIM OF PROVISIONAL APPLICATION RIGHTS

This application claims the benefit of U.S. Provisional Patent Application No. 60/612,336, filed on Sep. 23, 2004.

### BACKGROUND OF THE INVENTION

1. Field of the Invention

The present invention relates to log splitters and particularly to an adjustable cycle shortener for conventional log splitters, which comprises an adjustable length limiting rod attached to the control valve lever and having holes drilled therethrough and a movable hitch pin is provided that may be set at different holes in the rod for the length of log desired, thereby reducing travel of the retracting portion of the cycle and saving time on shorter logs.

2. Description of the Prior Art

Firewood is often burned as a heat source and in many situations is burned for the ambience and visual beauty other sources of heat cannot provide. Most people who have the desire to burn wood do not have a ready source of logs or the equipment or time to saw the logs into rounds and/or split the rounds into firewood. Accordingly, firewood is commonly sawn and split at one location and then sold by the cord (usually delivered) or smaller quantity to the end user.

Motorized systems have long been used to reduce the amount of effort required to split wood rounds into firewood. Conventional motorized wood splitters typically comprise a horizontal or vertical. I-beam having a hydraulic actuator securely mounted on one end and a small stop member mounted on the other end. The hydraulic actuator is connected to a wedge member, and extension and retraction of the hydraulic actuator extends the wedge member towards and away from the stop member. Typically, a guide track is provided for the wedge member.

During log splitting operations the operator must wait until after the return cycle of the splitter to begin splitting the next log. Saving time on each log being split would be very desirable in an operation splitting large numbers of logs to be able to split more logs per hour. One way of saving time in splitting each log is to shorten the return run of the log splitting device. Prior art devices do not adequately solve this problem for a range of existing log splitting devices.

U.S. Pat. No. 5,337,810, issued Aug. 16, 1994 to McCormack, shows a modified wood splitter featuring a hydraulically controlled log elevator, a log splitting piston stroke control rod, an adjustable four-way splitting wedge and a generator mounting apparatus all of which said features have been added to, for a significant improvement upon a conventional power driven wood splitter. The stroke control rod has an accompanying positioning pin and is attached to the head of the shaft of the device's wood splitting piston and held in situ along a track below the level of the wood splitting piston's housing but running parallel to the direction of the shaft of the piston which pushes logs along the track upon which they are to be split. The McCormack device is only practical for fixed wedge, movable pusher block type splitters. The McCormack device would be exposed to dirt and erratic movements of the split wood on a movable wedge type splitter.

U.S. Pat. No. 4,331,192, issued May 25, 1982 to Hung, provides a horizontal hydraulic wood splitter characterized with a length-adjustable bed, at one end of which is installed a fixed axe block, and at the other end a hydraulic pump unit or a jack of a type on the present market may be installed. By operating the pump unit, the wood accommodated on the bed will be pushed toward the axe and split. This mechanism is not only labor-saving and safe, but is also suitable for any size length of wood. In addition, the pump unit can be substituted with a jack for practical operation.

U.S. Pat. No. 5,373,877, issued Dec. 20, 1994 to Chapman, describes a log splitter having a log splitting station positioned between a log retaining plate and a hydraulic cylinder, both mounted upon an elongated frame. In use, the hydraulic cylinder, having a reciprocating piston rod to which a log splitting wedge is attached, pushes the wedge against a log positioned in the splitting station. A pump secured to the frame supplies pressurized hydraulic fluid to the hydraulic cylinder for movement of the piston rod. A valve, in fluid communication with the pump, regulates the flow of hydraulic fluid to the hydraulic cylinder. A knee pedal, positioned adjacent the log splitting station and associatively linked with the valve, selectively controls the hydraulic system and the motion of the reciprocating piston rod. To reduce the amount of time involved in splitting logs having a short length, a stop mechanism is provided for halting the movement of the piston rod prior to its complete retraction into the cylinder.

U.S. Pat. No. 4,498,293, issued Feb. 12, 1985 to Gregory, is for a force-delivering tool such as a log splitter wherein a pusher member carried on a cylinder is forced against a blade carried on a frame to which the piston is secured. The cylinder is driven relative to the piston by means of a reciprocating plunger carrying a cup on the end that forces fluid past a one-way valve, ahead of the piston. Oil is pressurized by both the bottom of the cup and its annular end but, when resistance is encountered to build up pressure a relief valve evacuates the annular chamber so that all the force is concentrated in the area at the bottom of the cup. The entire actuating valve may be backed away to relieve pressure as desired or at the completion of a desired stroke. An adjustable stop may be set in accordance with the length of the log so that the initial part of the next hydraulic stroke is not wasted in idle travel.

U.S. Pat. No. 3,242,955, issued Mar. 29, 1966 to Hellstrom, claims a log splitter having a power-driven ram that will, at the end of its stroke, automatically reverse its direction of movement and return to its normal at rest position. The ram has a first high splitting speed with moderate splitting force and a second low speed with high force. The log splitter's prime mover is automatically throttled to a low speed when the ram is at rest, but full operating speed is maintained during the retracting portion of the cycle, thus shortening the overall cycle time.

What is needed is a simple mechanical device attachable to a variety of conventional log splitters to shorten the length of the return cycle from the normal run of 24 or 30 inches for a full return to a return distance the approximate length of the wood being split.

### SUMMARY OF THE INVENTION

An object of the present invention is to provide a simple mechanical device attachable to a variety of conventional log splitters to shorten the length of the return cycle from the normal run of 24 or 30 inches for a full return to a return distance the approximate length of the wood being split to save a substantial amount of time in a log splitting operation.

A related object of the present invention is to provide a log cycle limiter which is suitable for either fixed or movable wedge type log splitters to enable retrofitting to the full range of makes and models of log splitters.

A further object of the present invention is to provide a return cycle limiter rod and pin which is attached to an existing log splitter in a hidden location under the hydraulic cylinder so that the parts are not exposed to dirt and to the erratic movements of the split wood on a movable wedge type log splitter.

One more object of the present invention is that it provides a log splitter cycle shortener which operates at low pressures requiring less than ten pounds pressure to activate for a very safe operation.

Another object of the present invention is that it stops the splitting wedge at any desired distance from the backstop to adjust for most sizes of logs being split to minimize the return time of the splitter for each of the different sizes of logs.

A corollary object of the present invention is that it is adjustable to different lengths within seconds without tools thereby saving more time.

Yet another object of the present invention is that it is simple and inexpensive to construct and would be simple to install on most common log splitters.

An auxiliary object of the present invention is to provide a means to make the control box attach directly to the hydraulic cylinder with a 45 degree elbow to allow the far end of the control valve lever to attach directly to the length limiter rod which places the knob of the control box lever at an ideal ergonomic position (which would be the height of a man's elbow).

Another corollary object of the present invention is that the shutoff bar is well able to withstand any pressure from split logs and impervious to dirt.

An associated object of the present invention is to provide on splitters with fixed splitting wedge guides (e.g. Huskee) the shutoff bar mounted directly behind the center of the splitting wedge (or push bar) and underneath the hydraulic cylinder and the shutoff guide would be extended out to its normal position. No change would be necessary for the length limiter rod.

Still another object of the present invention is to provide that when the hitch pin is moved to the rearmost hole, the splitter wedge returns to its fully retracted position.

In brief, the present invention is a very simple mechanical device added to a log splitter to allow it to stop at any point desired on the return cycle. Thus for splitters of shorter length wood, considerable time can be saved. It works by extending the inward end of the control valve lever and attaching a rod to it. Because the control valve lever rotates around its connection to the control valve housing, the inward end moves in the opposite direction. Thus when the lever is pushed back to return the slide wedge to its home/open position, the length limiter rod moves forward in the opposite direction. Therefore when the shutoff guide, which is attached to the slide wedge and is moving rearward, contacts the hitch pin on the length limiter bar, the bar is forced rearward, pulls the control valve lever with it to a neutral position, thus stopping further movement.

The present invention is a mechanical device attached to a conventional log splitter to shorten the length of the cycle from 24 or 30 inches to the approximate length of the wood being split. A proportionate amount of time is saved with each cycle. Thus a 24″ log splitter splitting 16″ wood will reduce the cycle time by one third, a considerable savings. The device can be adjusted very quickly to most any length short of the full length of the splitter's capacity by simply moving a hitch pin to the right hole. The holes were placed 2″ apart on the original device but could be placed at any interval and if desired, a custom hole could easily be drilled through the length limiter rod for any special length desired. The pin is simply moved but of the way when full-length logs are being split.

Since so many people split wood shorter than the full 24 or 30-inch capacities of the splitters, and since this device would be quite inexpensive in proportion to the cost of the splitter, it could benefit many people. This device can be changed without tools to different lengths in a few seconds, which will especially benefit people who split logs of varied lengths.

The present invention allows the operator of a log splitter so equipped to very simply, quickly, and without tools adjust the length of the splitting cycle to a shorter length to match the length of the wood he is splitting.

This reduction in the length of the cycle gives a corresponding reduction in the length of time for each cycle. Thus a 16″ cycle in a 24″ splitter will reduce the length of time of the cycle from 15 seconds to only 10 seconds, a reduction of ⅓ or 33% in time. Eighteen inch wood would reduce the same 24″ cycle by ¼.

An advantage of the present invention is that it saves time for anyone splitting wood shorter than the full capacity of the log splitter.

Another advantage of the present invention is that it is adjustable to stop the splitting wedge at any desired distance from the backstop.

An additional advantage of the present invention is that it is adjustable to different lengths within seconds without tools.

One more advantage of the present invention is that it requires less than 10 pounds pressure to activate the present invention so that it is very safe.

Yet another advantage of the present invention is that it is simple and therefore inexpensive to construct and simple to install on most common splitters.

Still another advantage of the present invention is that it allows easy access for changing log length positions.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a side elevational view of a Brave Model VHO234 log splitter beam with the Cycle Shortener device of the present invention added with the control valve lever shown in neutral, advance, and return positions. Because it is attached to the lever on the far side of the pivot point (located on the control valve housing) the length limiter rod moves in the opposite direction of the valve lever and the slide wedge. It is this opposite movement that allows the shutoff guide on the return cycle to push the control valve lever into the neutral position;

FIG. 2 is a top plan view of how the Cycle Shortener fits on the log splitter. It shows more of how the shutoff guide fits on the beam and onto the slide wedge;

FIG. 3 is an end elevational view in partial section of the splitter showing the invention attached to one model of log splitter with the cycle length limiter guide attached to a side of the splitter head away from the hydraulic cylinder arm and the length limiter rod tucked in underneath the cylinder to protect it;

FIG. 4 is an exploded perspective view of all the parts of the present invention plus a few parts of the splitter to which they are fastened for the log splitter model of FIG. 3;

FIG. 5 is an end elevational view in partial section of the splitter showing the invention attached to another model of log splitter with the cycle length limiter guide attached to a back center of the splitter head under the hydraulic cylinder arm and the length limiter rod tucked in underneath the cylinder to protect it;

FIG. 6 is an exploded perspective view of all the parts of the present invention plus a few parts of the splitter to which they are fastened for the log splitter model of FIG. 5.

### BEST MODE FOR CARRYING OUT THE INVENTION

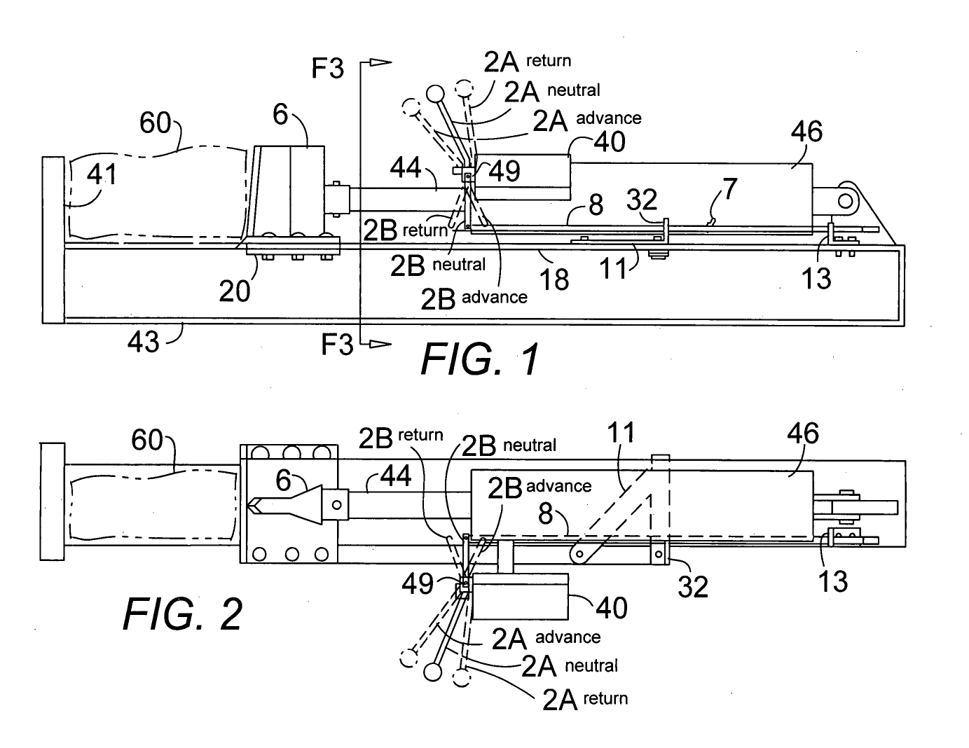

In FIGS. 1-6, an adjustable cycle length limiter device for log splitters enables a return cycle of a hydraulic log splitter element to be stopped at any of a number of adjustable desired stop settings based upon the length of the logs being split.

The cycle length limiter device comprises a replacement control lever 28 installed by a pivot element on a control box 40 of a hydraulic log splitter to substitute for a removed original control lever. The new control lever comprises an upper control handle 2A with the control knob 1 attached above the pivot element 49 to pivot from a central neutral position (2A neutral in FIGS. 1 and 2), forward to a forward advance position (2A advance in FIGS. 1 and 2) to advance a hydraulic log splitter arm 6 forward for splitting a log mounted on the hydraulic log splitter and backward to a back return position (2A return in FIGS. 1 and 2) to return the hydraulic log splitter arm to enable removal of a split log and insertion of a new log to split. A rigid lower extension 2B of the upper control handle 2A extends below the pivot element 49 of the control lever 2 so that the lower extension 2B moves in an opposite direction to the upper control handle, as shown in FIGS. 1 and 2.

A cycle length limiter rod 8 attaches at a first cycle length limiter rod end 31 to a bottom end of the lower extension 2B of the lever arm by a pivotable connection, such as an inverted U shaped yoke 30. The cycle length limiter rod 8 has a series of openings 50 along a length of a limiter portion of the cycle length limiter rod. A cycle stop element, such as a hitch pin 7, is insertable in one of the series of openings 50 of the cycle length limiter rod 8 so that the cycle stop element protrudes from the cycle length limiter rod 8. A return cycle length of the hydraulic log splitter element 6 and 20 is determined by which of the series of openings 50 holds the cycle stop element 7.

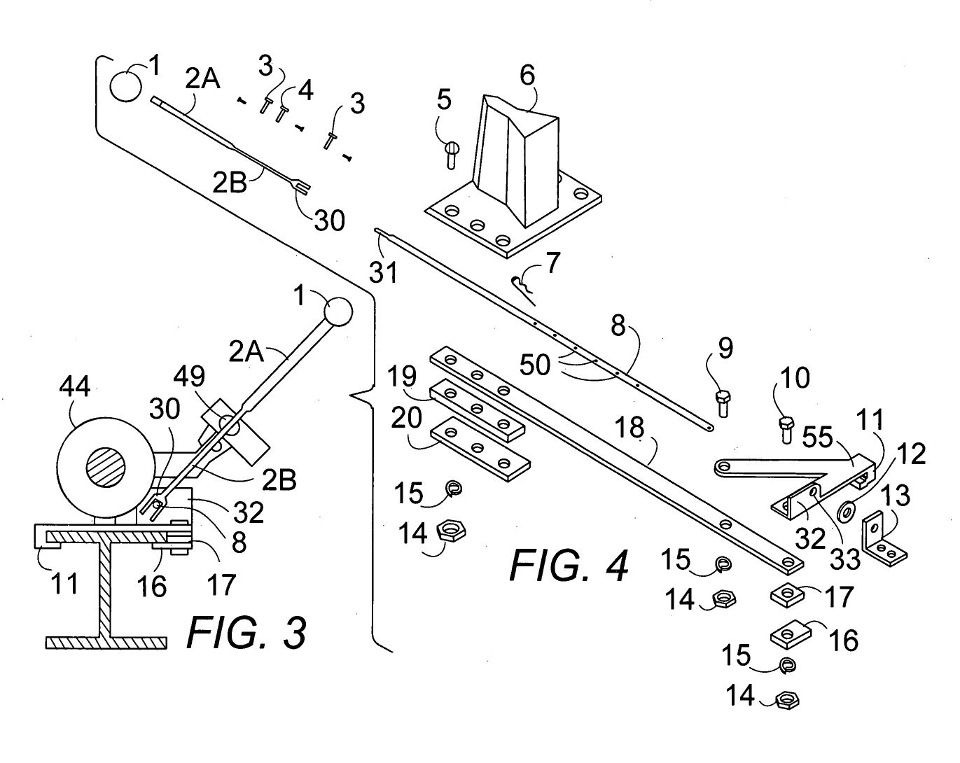

In FIGS. 3-6, the cycle length limiter guide 18 and 25 comprises an elongated rigid element, such as a metal bar, attached at a first cycle length limiter guide end by a rigid connector to the hydraulic log splitter arm 44 at the working end 6 and 21 of the log splitter arm. The cycle limiter guide 18 and 25 is attached at a second cycle length limiter guide end by a means, for sliding the cycle length limiter guide along a frame member of the hydraulic log splitter, the cycle length limiter guide further comprising a cycle length limiter rod frame, such as a vertically protruding tab 32 an 32A with an opening 33 and 33A to receive the limiter rod 8 therethrough, protruding from the second cycle length limiter guide end to receive the cycle length limiter rod 8 fitting slidably therein.

When the upper control handle 2A is pulled back to the return position, as shown in FIGS. 1 and 2, the lower extension 2B of the control handle pivots forward to move the cycle length limiter rod 8 forward and the hydraulic log splitter arm 44 moves backward to move the cycle length limiter guide 18 and 25 backward so that the cycle length limiter rod frame 32 and 32A engages the limiter element 7 in the cycle length limiter rod 8 to push the rigid lower extension 2A backward so that the upper control handle 2A pivots forward into the neutral position, as shown in FIGS. 1 and 2, to stop the return cycle of the hydraulic log splitter arm 44 a desired distance for inserting a log 60 of a desired length in the log splitter.

The upper control arm 2A is angled acutely, preferably 45 degrees, away from the hydraulic log splitter for ease of access and ease of use.

The cycle length limiter rod 8 is positioned under the log splitter hydraulic cylinder 46 to protect it from damage.

The cycle length limiter rod 8 is preferably fabricated of rigid lightweight metal tubing to keep the weight down and thereby minimize inertia on the control valve lever.

In FIGS. 3 and 4, the cycle length limiter guide 18 is attached to a side of a working end head 6 of the hydraulic log splitter arm. The means for sliding the cycle length limiter guide 18 along a frame member 46 of the hydraulic log splitter comprises a horizontal extension arm 55 extending orthogonally from a side of the second cycle length limiter guide end. The extension arm 55 comprises a rigid member having a hook element 11 at a distal end for hooking around a frame member 43 of the hydraulic log splitter to enable the cycle length limiter guide 18 to slide along the frame member parallel to the frame member.

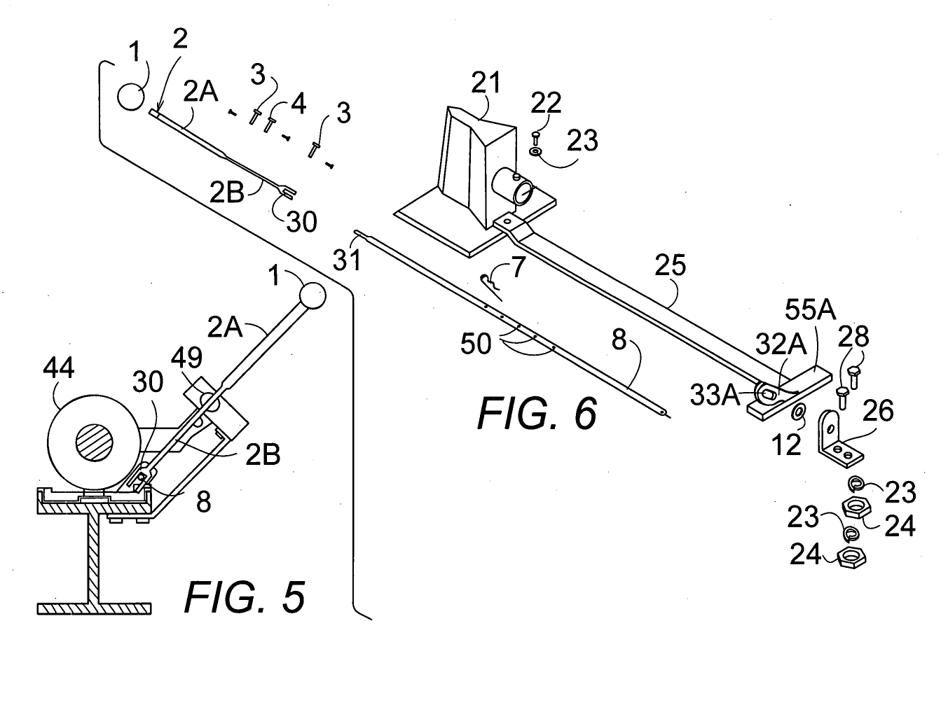

In FIGS. 5 and 6, the cycle length limiter guide 25 is attached to a back center of a working head 21 of the hydraulic log splitter arm under the hydraulic cylinder arm of a different model hydraulic log splitter. The means for sliding the cycle length limiter guide 25 along a frame member of the hydraulic log splitter comprises a horizontal flat elongated cross arm plate 55A attached in a center portion to the second cycle length limiter guide end to form a T shaped second cycle length limiter guide end with the cross arm plate slidable along a top of a log splitter frame member.

In practice, the original control valve lever is replaced with a new one. The new lever is extended 4⅜″ longer toward the splitter cylinder and a yoke constructed on the end to accommodate the length limiter rod. Different lengths will be necessary on different models. The ideal is to tuck the length limiter rod under the hydraulic cylinder a bit to protect it from damage. A 13/64-inch hole is drilled 5/16 inch from the end for a bitch pin. Second and third 13/64 inch holes are placed 4⅜″ and 5 7/16″ from the center of the first hole. The lever changes from a 14″×½″ flat bar ½″ from the third hole and angles off at 25 degrees as a ⅜″ rod 8⅛″ long threaded on the end to receive a 1¼ inch knob. Lengths will be different for different model splitters. The length limiter rod happens to be constructed of ⅜″ diameter brake line tubing. It could be constructed of any heavy-walled galvanized or otherwise surface-treated tubing, or a solid rod. Tubing was selected to keep the weight down and thereby minimize inertia on the control valve lever. It is 32⅜ inches long. The end that attaches to the control valve lever is flattened for 1 inch and a 13/64 inch hole is drilled ⅜ inch from the end. To stop the splitter at 16½ inch (on this particular model Brave splitter) a 3/32 inch hole is drilled at 18 13/16 inches from the center of the control valve lever attachment hole and at right angles (90 degrees) to it. To determine where the stopper hole should be in another splitter, stop the wedge at the distance you want; measure approximately 1⅛ inch from the far side of the shutoff guide and mark on the length limiter rod. Move the wedge forward (toward the backing plate) a few inches. Have or now place a flat washer on the length limiter rod just rearward of the shutoff guide. Firmly grip the length limiter rod at the mark. Move the wedge rearward until the shutoff guide hits your fingers and triggers a shutoff. (Since shutoff only requires 2 lbs. of pressure, there is little danger to your fingers). Experiment a bit until you have located the desired trigger point, then drill a 3/32″ hole at right angles to the control valve lever attachment hole (and parallel to the control valve lever). You may add other holes at arbitrary intervals for different desired log lengths. A last hole, preferably about 3/16 or 13/64″ can be placed ⅜″ from the far end and at right angles to the control valve lever attachment hole to hold the stopper hitch pin when it is not being used.

The dimensions given here are for a Brave Model VHO234 splitter. They will change for other models and makes, but the basic concepts will remain the same. The present invention works equally well on fixed wedge splitters or with slight modifications on Husky type splitters which have fixed wedge guides.

Construction of the shutoff guide is critical and dependent upon the model of the splitter used. On this machine, the control valve was repositioned to a 45 degree angle to the splitter to put the end of the control valve lever below the control valve's attachment to the splitter. This was done by replacing a straight nipple with a 45 degree angle coupling. On some models this repositioning may not be necessary. However, it is a very comfortable working position. The critical part of the shutoff guide is where to locate the elongated hole for the length limiter rod. We do this by placing the control valve lever in neutral position and determining the width in from the edge of the beam to the center of the length limiter rod plus 1½″ to bring the shutoff guide out to the full width of the shutoff bar.

Then measure the height above the beam less ¼″ for the thickness of the shutoff guide cross-bar. These two dimensions will locate the center of the lever and the inner 25/64″ hole in the vertical portion of the shutoff guide. Then move the control valve lever all the way forward (with the machine turned off) and all the way back. If one of these positions is more extreme, take your next measurements from this position. Again measure the height of the center of the length limiter rod from the beam less ¼″. Measure the width from the center of the rod to the edge of the beam plus 1½″ (for the connection to the Length Limiter bar). This gives you the center of the upper and outer 25/64″ hole. Drill out these two holes and remove the material between them to achieve a consistent 25/64″ width between the two sides of this slot. The vertical portion of the shutoff guide is then welded in an upright position on the far side of the crossbar portion of the guide coming out even with its end. The 45 degree angled portion of the guide is welded on. One-half-inch holes are drilled to attach the shutoff guide to the length limiter bar and they are connected with ½″-13 machine bolts.

The shutoff bar will vary in length according to the particular log splitter on which it will be used. The length is limited by the needed position of the shutoff guide. In the fully returned position it should be short of the rear end of the cylinder. In the fully advanced position it cannot be forward enough to interfere with the control valve lever. On this Brave Model VH0234 splitter, it is 24½″ long. It starts back ½″ from the leading edge of the base plate of the slide wedge. It has three ½″ holes corresponding to the holes in the base plate. A different, thinner shim (⅜″ vs. ⅝″) is used, replacing the original shim The shutoff bar continues alongside the beam until it reaches the far end of the shutoff guide. A small ⅜″ thick shim and a small slide guide are added here. They are all drilled out and bolted together with ½″-13 machine bolts.

The last piece is the length limiter guide. It can be constructed out of a 2½×2½×¼ inch angle iron or bent out of flat iron. Again, dimensions will vary according to the model of log splitter. For this Brave model VH0234 splitter, a piece of 2½ inch angle iron was cut to 2½′″ long. 1½″ wide, and 1¾″ high. Again, measure the height from the beam and the distance in to the center of the L.L. rod when in the neutral position Use these dimensions to locate the 25/64″ hole in the guide. Two holes are drilled in the base of the guide and two corresponding holes in the beam. The guide is placed a bit past the far end of the cylinder. The guide is then bolted to the beam

During assembly, the far end of the length limiter rod is passed through the shutoff guide, the flat washer is then added to the rod, and then it passes through the length limiter guide. Lastly, it is fastened to the control valve lever with a clevis pin. The stopper hitch pin is then added in whatever position is desired.

The present invention allows the operator of a log splitter so equipped to very simply, quickly, and without tools adjust the length of the splitting cycle to a shorter length to match the length of the wood he is splitting.

It is understood that the preceding description is given merely by way of illustration and not in limitation of the invention and that various modifications may be made thereto without departing from the spirit of the invention as claimed.

What is claimed is:

1. An adjustable cycle length limiter device for log splitters, the device comprising:
a replacement control lever installed by a pivot element on a control box of a hydraulic log splitter to substitute for a removed original control lever, the new control lever comprising an upper control handle above the pivot element to pivot from a central neutral position forward to a forward advance position to advance a hydraulic log splitter arm forward for splitting a log mounted on the hydraulic log splitter and backward to a back return position to return the hydraulic log splitter arm to enable removal of a split log and insertion of a new log to split, and a rigid lower extension of the upper control handle extending below the pivot element of the control lever so that the lower extension moves in an opposite direction to the upper control handle, a cycle length limiter rod attached to a first cycle length limiter rod end to a bottom of the lever arm by a pivotable connection, the cycle length limiter rod having a series of openings along a length of a limiter portion of the cycle length limiter rod, a cycle stop element insertable in one of the series of openings of the cycle length limiter rod so that the cycle stop element protrudes from the cycle length limiter rod, a return cycle length of the hydraulic log splitter element being determined by which of the series of openings holds the cycle stop element, a cycle length limiter guide comprising an elongated rigid element attached at a first cycle length limiter guide end by a rigid connector to the hydraulic log splitter arm of the log splitter and the cycle limiter guide attached at a second cycle length limiter guide end by a means for sliding the cycle length limiter guide along a frame member of the hydraulic log splitter, the cycle length limiter guide further comprising a cycle length limiter rod frame protruding from the second cycle length limiter guide end to receive the cycle length limiter rod fitting slidably therein, so that when the upper control handle is pulled back to the return position, the lower extension of the control handle pivots forward to move the cycle length limiter rod forward and the hydraulic log splitter arm simultaneously moves backward to move the cycle length limiter guide backward so that the cycle length limiter rod frame engages the limiter element to push the rigid lower extension backward so that the upper control handle pivots forward into the neutral position to stop the return cycle of the hydraulic log splitter arm a desired distance for inserting a log of a desired length in the log splitter.

2. The device of claim 1 wherein the upper control arm is angled acutely away from the hydraulic log splitter for ease of access and ease of use.

3. The device of claim 1 wherein the rigid lower extension further comprises an inverted U shaped yoke constructed on a bottom end thereof for engaging the first cycle length limiter rod end.

4. The device of claim 1 wherein the cycle length limiter rod is positioned under the log splitter hydraulic cylinder to protect it from damage.

5. The device of claim 1 wherein the cycle length limiter rod is fabricated of rigid lightweight metal tubing to keep the weight down and thereby minimize inertia on the control valve lever.

6. The device of claim 1 wherein the cycle length limiter guide is attached to a side of a working end head of the hydraulic log splitter arm.

7. The device of claim 6 wherein the means for sliding the cycle length limiter guide along a frame member of the hydraulic log splitter comprises a horizontal extension arm extending orthogonally from a side of the second cycle length limiter guide end, the extension arm comprising a rigid member having a hook element at a distal end for hooking around a frame member of the hydraulic log splitter to enable the cycle length limiter guide to slide along the frame member parallel to the frame member.

8. The device of claim 1 wherein the cycle length limiter guide is attached to a back center of a working head of the hydraulic log splitter arm under the hydraulic cylinder arm.

9. The device of claim 8 wherein the means for sliding the cycle length limiter guide along a frame member of the hydraulic log splitter comprises a horizontal flat elongated cross arm plate attached in a center portion to the second cycle length limiter guide to form a T shaped second cycle length limiter guide end with the cross arm plate slidable along a top of a log splitter frame member.
